(19) United States
(12) Patent Application Publication
(10) Pub. No.: US 2010/0031857 A1
(43) Pub. Date: Feb. 11, 2010

(54) Sequential safe door opening

(75) Inventor: Brett Dunstan, Hallam (AU)

Correspondence Address: D. PETER HOCHBERG CO. L.P.A., 1940 EAST 6TH STREET, CLEVELAND, OH, 44114, US

(73) Assignee: LOKAWAY PTY. LTD., Hallam (AU)

(21) Appl. No.: 12/462,917

(22) Filed: Aug. 11, 2009

(30) Foreign Application Priority Data
Aug. 11, 2008 (AU) 2008904078

(51) Int. Cl. E06B 3/36; E05B 3/00; E05C 1/06

(52) U.S. Cl. 109/74; 292/336.3; 292/140

(57) ABSTRACT

In safes and security doors of the swing and slide type the door edge slides in and out of a slot in order to prevent it being pried open. The slide motion is supplied by a rotatable handle on the door itself. The action of sliding into the slot is accompanied by the extension of multiple bolts which shoot from the door edge into keepers in the safe body or door frame. The rotation of the handle is coupled to a cam which retracts the bolts first and slides the door to the position where it is ready to open in a defined sequence. Likewise, the door swings shut, contacts a landing surface, slides into the slot and the bolts extend. A variant for a door with slots which rides on a group of pins is described. The cam is locked by a key or digital lock.

### CROSS-REFERENCE TO RELATED APPLICATION

This application claims priority of Australian Provisional Application No. 2008904078 filed on Aug. 11, 2008.

### BACKGROUND OF THE INVENTION

1. Field of the Invention

This invention concerns security door and frame construction and relates primarily to safes but is applicable to security doors.

2. Description of the Prior Art

In our co-pending application for Patent No. 2003252867, we describe security door constructions of the swing and slide type. The door frame has an upright for supporting the door on an offset hinge assembly and the upright of the frame opposite the offset hinge assembly has a slot capable of receiving the closing edge of the door, which upon closing slides into the slot and upon opening, slides out of the slot. In addition, the door has a rotatable handle which turns a link and the link reacts against the hinge assembly causing the door to slide in and out of the door slot. This type of security door is hereafter referred to as a security door of the type described.

The slide motion of the door precedes the opening swing and it is this retraction of the door from the slot which intruders try to achieve. The door is free to slide on the hinges and must be retained in the locked position by door bolts. We describe hook and slot formations in the above application which resist prying forces applied to the door. In co-pending Australian application no. 2004231234, we describe a horizontal bar which slides across the width of the door when the safe is locked and abuts the safe wall adjacent the door hinge. Prying forces tending to slide the door open are transmitted to the safe wall and resisted.

In co-pending Australian Application No. 2005901184, we describe door mounted rise and fall hooks which drop into vertical slots in the closing stile of the door frame when the door is locked. These are both effective measures for resisting forces exerted by prying bars applied to the door frame, that is between the door and the closing style.

In safes such as gun safes which are made from plate 2-3 mm thick, the above devices exert locking force at various sites and the metal between these sites could be bent. It would be desirable to resist prying by increasing the difficulty of inserting the prying bar into the gap between the door and the closing style so that effective leverage cannot be applied.

The prior art includes safes with a swing and slide action which do not rely on a double hinge. Such safes instead have a single pivot axis for a swinging frame upon which a door is mounted with freedom to slide left and right. The slide motion of the door allows the door to project into a door slot in the body of the safe. This invention is applicable to this type of swing and slide door motion.

This specification describes embodiments of swing and slide safes which combine features shown by testing to resist attack most effectively in relation to the cost of machinery operations required to provide resistance to attack.

### SUMMARY OF THE INVENTION

The apparatus aspect of the invention provides a swing and slide security door of the type described for a safe having a handle, the motion of which both (a) imparts sideways slide motion to the door, and (b) actuates at least one door mounted locking assembly which engage and disengage the body of the safe, wherein initial handle motion imparts sideways slide motion to the door toward the CLOSED position, whereafter further handle motion causes the locking assembly to lock and initial handle motion in the opposite direction causes the locking assembly to unlock whereafter further handle motion imparts sideways motion to the door toward the OPEN position.

Preferably the handle has link to a reaction surface on the hinge assembly of the door rotation of which causes the door to slide sideways.

The locking members may be one or more bolts which move in and out of engagement with a corresponding number of bores in the adjacent body or frame.

Instead of being directly connected to the handle like or latch, the locking assembly may include a connecting link which joins a bolt adjacent the edge of the door to the handle which may be more centrally placed. The link may in turn be connected to one or more further links which transfer handle motion to a gang of bolts disposed adjacent the door edge. Thus the handle acts like a crank and the link acts like a connecting rod.

The sitting of bolts along the door edge considerably strengthens resistance to prying.

Such multiplication of movement makes it easy to include locking assemblies with bolts which enter and leave the body or frame around the door.

The handle crank may be a disc or plate with an arcuate slot intended for engagement with a bolt extending from the bolt link. The disc or plate may also have projections intended to be obstructed by one or more locks requiring a key or keypad to operate. These locks control the rotation of the handle and are the point of entry for the operator.

The disc or plate is connected to a reaction link which extends across the width of the door to the hinge assembly where the upright rod or tube acts as a reaction surface. The reaction link enables the operator to impart slide motion to the door, whereas the bolt follower link transfers motion to the bolts.

The safe may have a closing style which provides a landing surface for the safe door and a pocket for housing the closing edge of the door, wherein the door has an outwardly turned closing edge for the purpose of denying access to the door edge by a pry tool inserted between the door and the closing style.

The closing style may have a portion against which the outward face of the door is intended to abut in the closed position and the pocket has a ramp surface adjacent the landing surface which the closing edge contacts as the door slides to the closed position in which locking follows and passage of the closing edge over the ramp surface forces the front face of the door against the portion of the closing style.

The inclined portion of the slot may have a front inclined wall and a rear inclined wall. The rear inclined wall acts as a ramp surface contacted by the rear surface of the door edge as the door closes causing the door edge to abut the door stile tightly.

The outwardly turned closing edge may form a narrow flange.

The front inclined wall acts as a ramp surface for the flange, directing the door away from the door stile toward the landing surface when the door is slid open.

The front inclined wall may be formed by bending the free edge of the closing style.

The landing surface may be provided by a wall parallel to the door but projecting from the safe wall adjacent the closing style.

The rear inclined wall may extend from the projecting wall to the closing style.

It is convenient if the rear inclined wall is part of a component of modified channel section which permits reinforcement of the hollow door style. Reinforcement is made possible by giving the component a profile which partly matches the door style profile and during manufacture putting the component inside the channel part of the door style so that the component and channel fit face to face and increase the stiffness of the closing style.

The flange may be formed by bending the door edge and may be 5-15 mm deep, preferably 10 mm deep. In this specification the term “flange” is intended to include a lip made by bending a single plate at 70-90°; a projection at 90° made by fabricating bent sections; a lip with an integral incline which is intended to assist the exit of the door from the door pocket. The flange may be of constant or tapering thickness.

The second aspect of the invention provides a security door of the type having a door which slides left and right on a swinging frame having a handle, the motion of which both (a) imparts sideways slide motion to the door, and (b) actuates at least one door mounted locking assembly which engages and disengages the body of the safe, wherein initial handle motion imparts sideways slide motion to the door toward the closed position, whereafter further handle motion causes the locking assembly to lock and initial handle motion in the opposite direction causes the locking assembly to unlock whereafter further handle motion imparts sideways motion to the door toward the open position.

### BRIEF DESCRIPTION OF THE DRAWINGS

One embodiment of the invention is now described by way of example with reference to the accompanying drawings, in which:

FIG. 1 is a rear view of the door of a safe with the door in the CLOSED position and locked.

FIG. 2 is an enlarged view of FIG. 1 with the bolts in the locked position and the door engaging the door slot as far to the right as the door will slide.

FIG. 3 is the same view as FIG. 2 but with the bolts partially retracted and the door beginning to slide to the left.

FIG. 4 is the same view as FIG. 2 with the bolts fully retracted and the door fully retracted to the left allowing the door to swing open.

FIG. 5 is a plan view of the parts according to FIG. 2.

FIG. 6 is a variant of the version shown in FIGS. 1-5.

FIG. 7 is a simplified variant relying on both latch and bolts for locking shown in the locked condition.

FIG. 7a is a rear view of the operation of the door of the safe as shown in FIG. 7 in the unlocked condition.

FIG. 8 is a rear view of a door assembly of the type wherein no double hinge is present. Instead the door slides left and right on the projecting bolts of a swinging door frame.

FIG. 8a is a rear view of the operation of the door of the safe as shown in FIG. 8 showing the sliding of the door.

FIG. 9 is a rear view of a safe door with bolts in the lock position.

FIG. 10 is the same as FIG. 9 with the bolts in the unlock position.

FIG. 11 is a perspective of a corner of the safe body with the door open.

### DETAILED DESCRIPTION OF THE PREFERRED EMBODIMENTS

The safe body and door are constructed substantially according to the embodiment described in PCT/AU03/01321 (now U.S. Pat. No. 7,404,363), incorporated herein by reference. The body has a channel section door style and a closing style which defines a slot into which the door slides once the door has swung into the closed position. When the door is opened it first slides sideways in order to retract the closing edge of the door from the slot, whereafter it is free to swing on an offset hinge assembly. In this specification the components which are common to our earlier applications show the same earlier numerals. The components which are extra and comprise the features of this invention are given their own numerals.

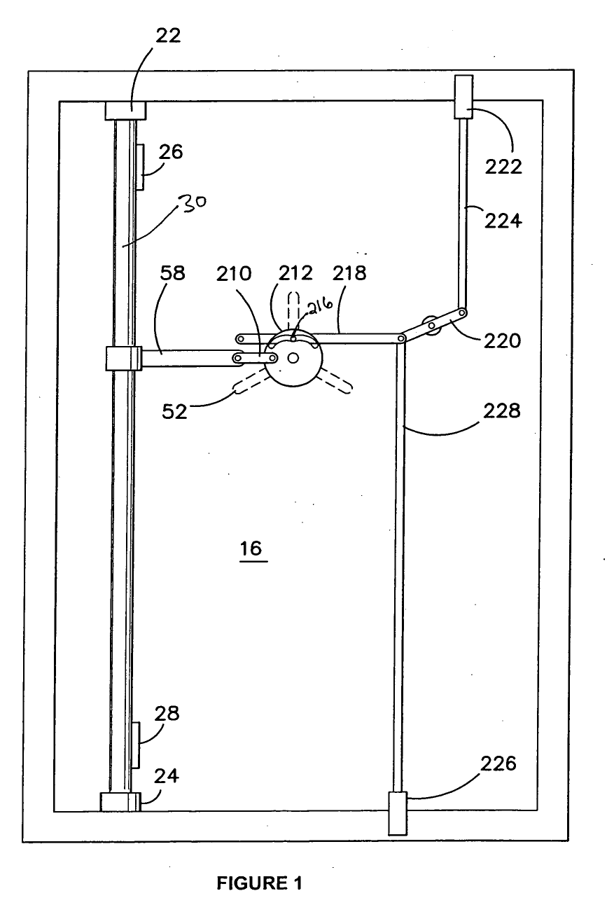

Referring now to the drawings, a door 16 is mounted on door hinges 22, 24 which are carried on a vertical steel tube 30. Tube 30 is free to rotate in frame hinges 26, 28. A reaction bar 58 is connected at one end to tube 30 and at the opposite end to a link 210. A handle 52 turns a disc or cam 212 on an axle which passes through the thickness of door 16. Disc 212 has a profiled slot 214 engaged by a bolt 216 of a lifter bar 218 which acts as a follower. When disc 212 is turned by the handle it acts as a crank. Profiled slot 214 is of shallow M shape. The ends of slot 214 curve downward and are joined by a central inverted bow. When handle 52 is in the locked position, bolt 216 lies in the center of the central inverted bow as seen in FIG. 1.

As reaction bar 58 remains static, the only part which is free to slide is the door 16. Door 16 slides left or right as the operator turns handle 52. The parts shown in the drawing except tube 30 and frame hinges 26, 28 are supported on the rear face of door 16.

Lifter bar 218 actuates double arm lever 220 which, like disc 212 is mounted on the rear face of door 16. One arm transfers motion to upper bolt 222 via rod 224 and identical motion in the reverse direction to lower bolt 226 via rod 228.

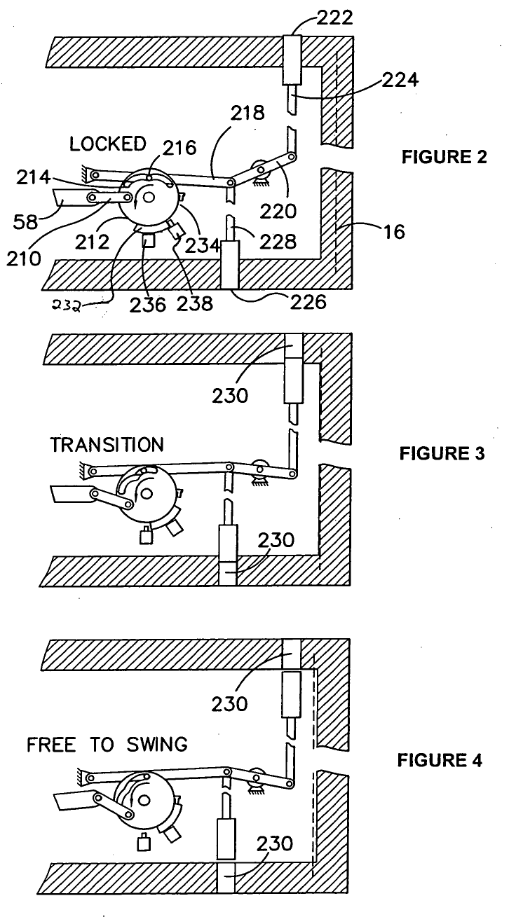

Bolts 222, 226 are 30 mm in diameter and shoot into bores 230 in the safe wall. Rotation of disc 212 moves bolt 216 through about 80°. FIGS. 2, 3 and 4 show disc 212 and door 16 progressing from the locked position in FIG. 2 to the left while reaction bar 58 remains static.

In FIGS. 2-4, door 16 slides from right to left as door 16 is slid open, but an important sequence also occurs. When handle 52 rotates counterclockwise out of the locked position, the bow of slot 214 pushes bolt 216 upwards and lifter bar 218 immediately retracts bolts 222, 226. As handle 52 rotates further, the downwardly curved portion reaches bolt 216 and the lifting effect stops, but bolt 216 remains where it is while link 210 drops and door 16 slides to the left. In FIG. 2, the initial rotation of disc 212 pushes lifter bar 218 upwards causing immediate retraction of both bolts 222, 226. The first few degrees take up the play in the linkage whereupon bolts 222, 226 quickly retract and disengage from bores 230.

Next, further rotation of disc 212 pulls door 16 to the right and door 16 begins to leave door slot 14 but is not yet free to open as seen in FIG. 3.

Still further, rotation of disc 212 moves bolts 222, 226 to the position shown in FIG. 4 where bolts 222, 226 are clear of the door edge and the door edge is clear of the frame edge leaving door 16 free to swing open.

The locking sequence of door 16 is the reverse of the operation discussed above. The entry of the door edge into door slot 14 is concluded by bolts 222, 226 engaging bores 230.

Referring again to FIGS. 2-4, disc 212 has a sector with a circumferential projection 232 which carries an arcuate stop 234. Arcuate stop 234 lies in the arc of disc 212 as shown in FIG. 2 and is adjustable by a fastener such as a screw. Projection 232 rotates between the position shown in FIG. 2 to reach arcuate stop 234 in FIG. 4. A key operated lock 236 obstructs stop 234. A keyboard operated solenoid 238 also obstructs stop 234. Key operated lock 236 and keyboard operated solenoid 238 permit manual opening by the operator in the event of battery failure between keyboard and solenoid. The handle allows manual force to move all the levers, carriers and bolts, but lock 236 allows the operator to insert a key from outside and cause a tongue 237 to emerge and block the rotation of disc 212 in both directions. Lock 238 is solenoid operated and has an armature 239 which emerges to block rotation of disc 212. This is operated by a battery (not shown) in a keypad lock (also not shown) on the door outside the safe. All safes have locks but it is novel to use locks for keeping disc 212 or a cam in the required position. Unlocking is achieved by reversing the condition so tongue 237 and/or armature 239 retract inside respective locks 236, 238.

In a variant construction door 16 is 500 mm wide and bolts 222, 226 are arranged on a vertical axis 75 mm from the closing edge. Bolts 222, 226 are 25-35 mm in diameter and project 35-50 mm into the body of the safe. If multiple bolts are used they are arranged with equal spacing around the edge of door 16.

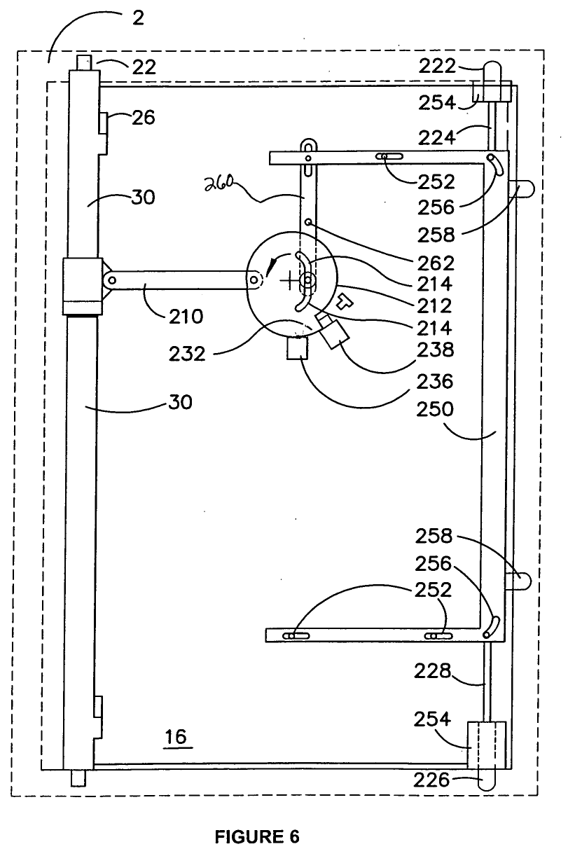

In FIG. 6, bolts 222, 226 are extended and retracted by a C-shaped bolt carrier 250 which slides left and right on bolts 252. Bolts 222, 226 slide in pockets 254. Rods 224, 228, which actuate bolts 222, 226, ride in inclined slots 256 cut in the corners of carrier 250. The vertical leg of carrier 250 carries a pair of horizontal bolts 258 which enter the wall 2 of the safe.

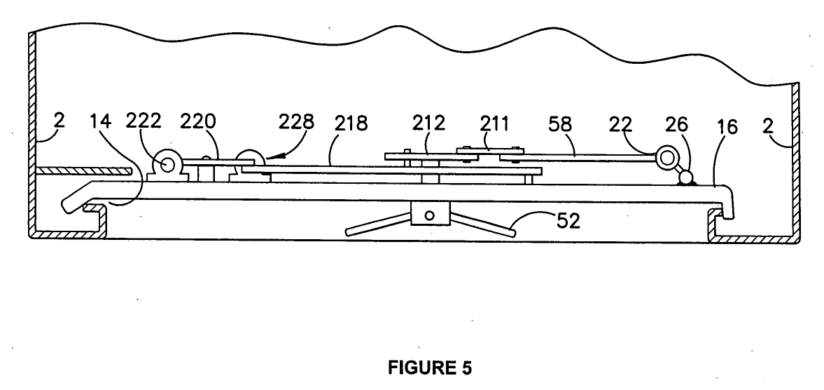

Carrier 250 is slid left and right by follower 260 mounted on a horizontal pivot 262. Follower 260 has bolts (unlabeled) at both ends and is rotated by the engagement with the profiled slot 214. As disc 212 rotates around the center marked + by handle 52 (see FIG. 5), bolts 222, 226, 258 immediately retract in order to move inside the door perimeter. As profiled slot 214 rotates the door slide motion increases and door 16 clears door slot 14.

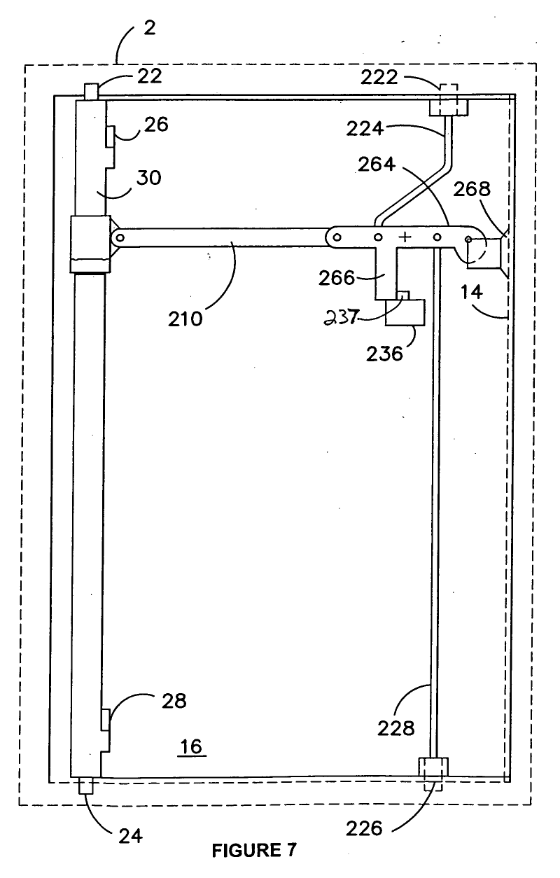

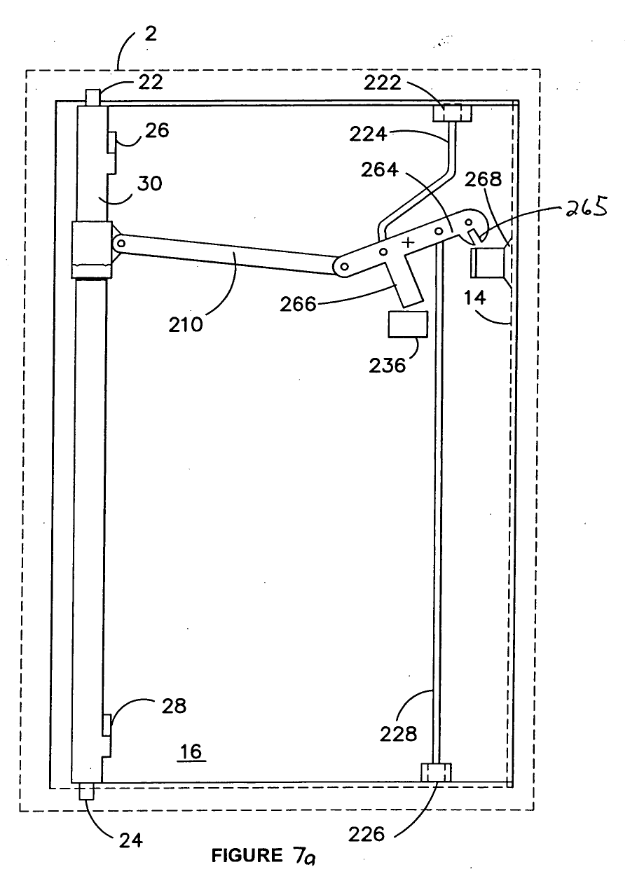

In FIG. 7 and FIG. 7a, disc 212 is replaced by a T-shaped latch 264 which rotates about the center marked +. T-shaped latch 264 includes a latch leg 266 which engages lock 236 in the locked position as shown in FIG. 7. Lock 236 can be key operated or keypad operated as a solenoid as mentioned above. T-shaped latch 264 also includes a latch mouth 265 as shown in FIG. 7a. Latch mouth 265 engages a square bracket 268 attached to door edge 14 in the locked position. When key lock 236 is open, latch leg 266 is unobstructed and T-shaped latch 264 is free to rotate from the locked position into an unlocked position by having latch mouth 265 disengage square bracket 268. As soon as key lock 236 is opened, T-shaped latch 264 lifts away from bracket 268 and at the same time rods 224, 228 retract bolts 222, 226. After initial rotation of T-shaped latch 264 to retract bolts 222, 226, then further rotation of T-shaped latch 264 slides door 16 out of door slot 14. FIG. 7a shows the operation of this embodiment with the tongue (not shown) of lock 236 retracted and latch 264 and bolts 222, 226 withdrawn but the door edge is still within slot 14.

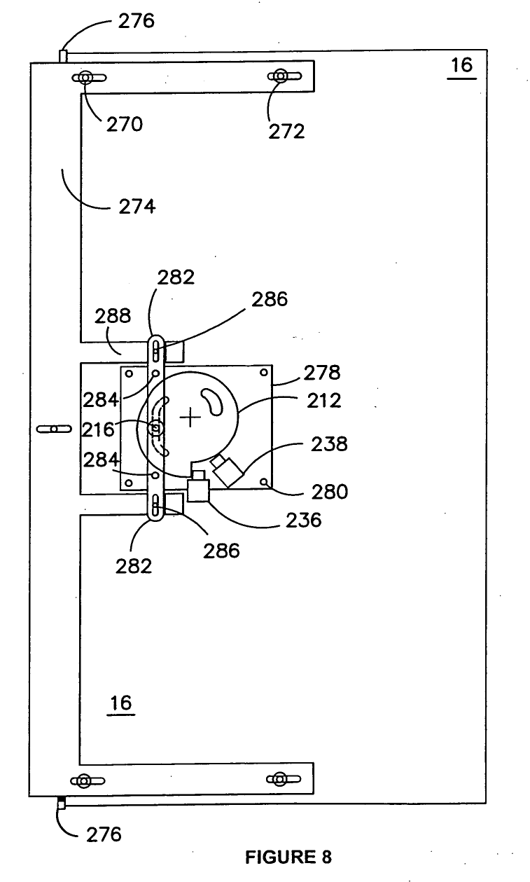

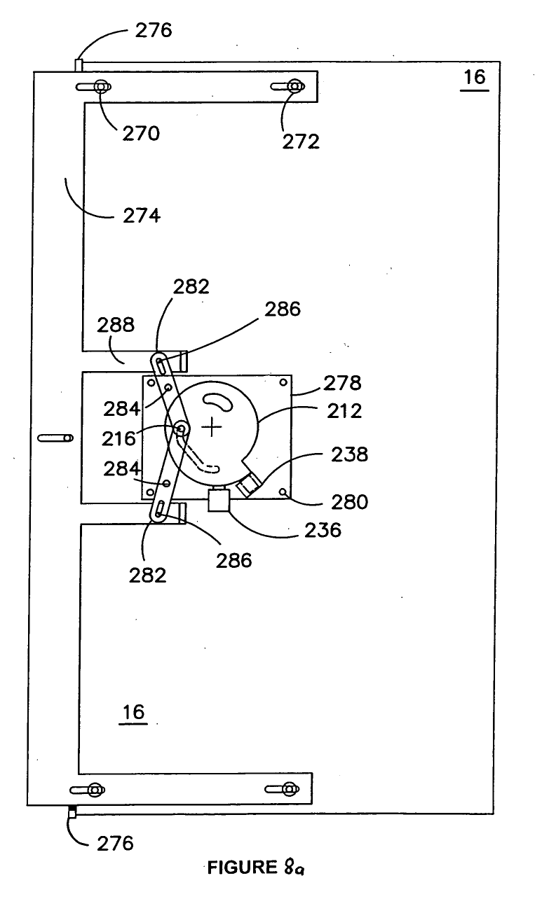

In FIG. 8 and FIG. 8a, the door 16 slides left and right on five bolts or horizontal door pins 270 which project from door 16 and end in retaining heads 272. Door 16 is mounted on a modified steel E-frame 274 which swings around vertical hinge bolts 276. A steel plate 278 is secured to the door face by posts 280 which plate mounts disc 212 and locks 236 and 238. In addition, a pair of followers 282 is free to rotate on horizontal bolts 284 which extend from plate 278. Followers 282 overlap above common bolt 216. As profiled slot 214 progresses as shown in FIG. 8a, followers 282 rotate about horizontal bolts 284 and transfer sideways motion to bolts 286 fixed to mid arms 288 of frame 274 as shown in FIG. 8a. Frame 274 swings on vertical hinge bolts 276 and the slide motion of door 16 is realized through five bolts 270 sliding left and right on the slots cut in frame 274. As frame 274 can swing but not slide, the handle rotation causes door 16 to slide left or right and to move in and out of door slot 14 in the safe body.

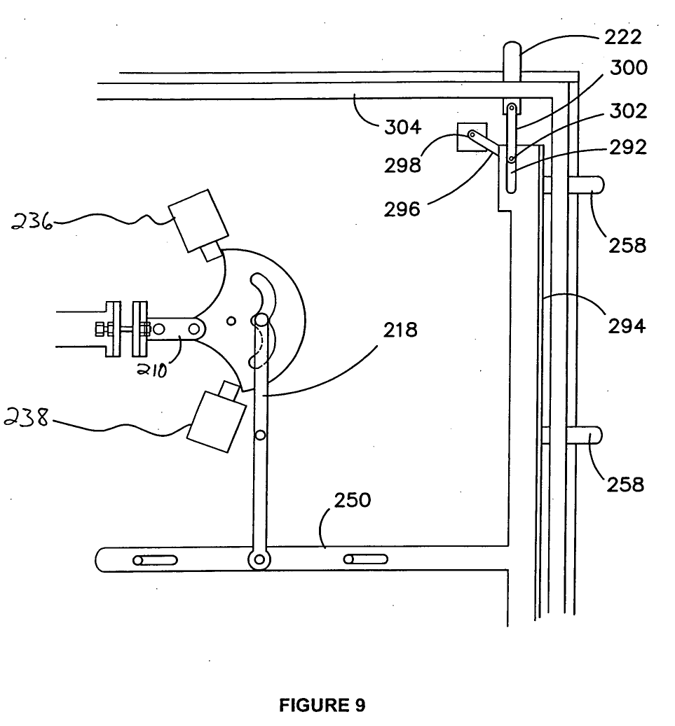

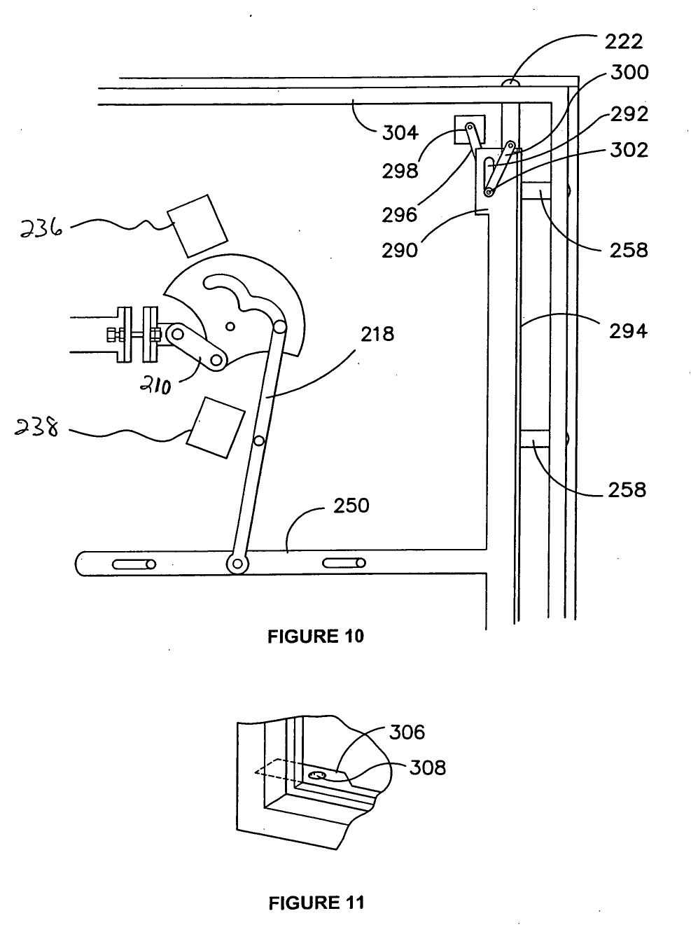

In FIG. 9 and FIG. 10, carrier 250 is T-shaped, the T-bar ending in rectangular plates 290, each with a vertical slot 292. The leading edge of carrier 250 has a 90° flange 294 from which horizontal bolts 258 project. Carrier 250 may be made out of sheet metal.

Disc 20 of the earlier embodiments is modified to a fan shape, the vertex being connected to link 210 and the corners abutting stops 236, 238. Slot 214 comprises two identical arcs so that follower 218 produces mirrored motion when handle 52 rotates clockwise or counterclockwise. In this way disc 20 acts as a cam producing precise, reliable locking and unlocking.

The rise and fall motion imparted to the bolts (only 222 is shown) is shown in FIG. 10. Rods 224, 228 of FIG. 6 are replaced by a radius arm 296 pivoted to a mount 298 on the inside face of door 16 and a bolt arm 300 pivoted to the proximal end of bolt 222, 226. The opposite ends of arms 300 are joined for articulation and support a pin 302 which rides in a vertical slot 292. As carrier 250 moves left and right, the bolt arm 300 moves in an arc and pin 302 slides in slot 292 extending and retracting the vertical bolts 222, 2226 while carrier 250 moves horizontal bolts 258 directly.

As shown in FIGS. 9 and 10, the inside of door 16 has a continuous rectangular raised wall 304 which forms a shallow box. Bolts 222, 226, 258 project through raised wall 304. The box is closed by a cover (not shown) pivoted to an upright edge of the box. The lower part of the box is occupied by shelves.

FIG. 11 shows that where the safe body relies on bolts for security, the upstands and hooks in our earlier patent applications as referenced herein are not required. Instead the styles are joined by a top and bottom strip 306 (only one shown) which has a bore 308 to receive bolt 226.

It is to be understood that various modifications of and/or additions to the invention can be made without departing from the basic nature of the invention. These modifications and/or additions are therefore considered to fall within the scope of the invention.

What is claimed is:

1. A swing and slide security door for a safe comprising:
a rotatable handle for imparting sideways slide motion to the door and for actuating at least one door mounted locking assembly for engaging and disengaging the safe, said door moving in a sideways slide direction and at least one door mounted locking assembly being actuated in response to rotation of said handle;
wherein said handle rotation comprises:
an initial handle rotation in one direction for imparting sideways slide motion to the door to a closed position and a continued handle rotation in the same direction causing said locking assembly to lock in said closed position, and
an initial handle rotation in the opposite direction causing said locking assembly to unlock and a continued handle rotation in the opposite direction imparting sideways motion to the door to an open position.

2. A swing and slide security door as claimed in claim 1, wherein said locking assembly comprises at least one bolt moving in and out of engagement with at least one corresponding bore in a frame of the safe in response to movement of said handle in the one direction and the opposite direction.

3. A swing and slide security door as claimed in claim 2, wherein said locking assembly further comprises a reciprocal bolt carrier mounted on a rear face of the door, said reciprocal bolt carrier having ganged vertical bolts extending therefrom.

4. A swing and slide security door as claimed in claim 3, wherein said locking assembly further comprises a cam for driving a cam follower, wherein said follower reciprocates said bolt carrier causing said vertical bolts to engage and disengage said frame in response to movement of said handle in the one direction and the opposite direction.

5. A swing and slide security door as claimed in claim 3, wherein said bolt carrier further comprises carrier ends, each said carrier end comprising:
a vertical slot adjacent to a horizontal bolt mounted on said rear face of the door; and
a linkage mounted on said rear face of the door cooperating with said vertical slot causing said vertical bolts to extend into the top and bottom of said frame when said horizontal bolts engage the upright edge of said frame.

6. A swing and slide security door as claimed in claim 5, wherein said linkage further comprises a pair of links joined for articulation at a common end to form an articulation joint, the opposite end of the first link being pivoted to the rear of the door and the opposite end of a second link being pivotally connected to one of said vertical bolts, the articulation joint engaging the carrier slot, whereby reciprocation causes partial rotation of the links and consequent rise and fall of said vertical bolts.

7. A swing and slide security door as claimed in claim 4, wherein said cam follower engages a slot in the cam, said slot comprising a shallow M shape.

8. A swing and slide security door as claimed in claim 7, wherein said locking assembly further comprises at least one lock fixed to said rear face of the door requiring a key or keypad actuable to enable operation of said locking assembly from a locked condition, said at least one lock obstructing rotation of said cam when said locking assembly is in the locking condition.

9. A swing and slide security door as claimed in claim 4, wherein said cam comprises:
a fan-shaped plate having an apex; and
a pivot near said apex of said fan for rotation of said cam.

10. A door as claimed in claim 1 incorporated in a safe.

11. A security door for sliding left and right on a swinging frame, said security door comprising:
a movable handle for imparting sideways slide motion to the door and for actuating at least one door mounted locking assembly for engaging and disengaging the safe in response to motion of said handle;
wherein said handle motion comprises:
an initial handle motion in a direction imparting sideways slide motion to the door to a closed position and a continued handle motion in the same direction causing said locking assembly to lock in said closed position, and
an opposite initial handle motion causing said locking assembly to unlock and a continued opposite handle motion imparting sideways motion to the door to an open position.
